(19) United States
(12) Patent Application Publication
(10) Pub. No.: US 2013/0135713 A1
(43) Pub. Date: May 30, 2013

(54) Lens for Infrared Cameras

(71) Applicant: Tamron Co., Ltd., Saitama-shi (JP)

(72) Inventor: Koji Kawaguchi, Kasukabe-shi (JP)

(73) Assignee: TAMRON CO., LTD., Saitama-shi (JP)

(21) Appl. No.: 13/679,255

(22) Filed: Nov. 16, 2012

(30) Foreign Application Priority Data
Nov. 30, 2011 (JP) 2011-262104

(51) Int. Cl. G02B 13/14

(52) U.S. Cl. CPC G02B 13/14
USPC 359/354

(57) ABSTRACT

This invention is directed to provide an infrared camera lens that is simple in lens configuration and has lens pieces including only spherical surfaces but no aspheric surfaces. The invention is also directed to provide an infrared camera lens of a design that facilitates and implements an airtight environment within the lens barrel because the foremost or first lens closest to the object stays still during focusing, and the entire length of the lens system is unchanged for focusing. The infrared camera lens comprises the foremost or first single spherical lens piece of positive refractivity, the succeeding or second single spherical lens piece of negative refractivity, and the third single spherical lens piece of positive refractivity. At least the second single spherical lens piece of negative refractivity or the third single spherical lens piece of positive refractivity is to be moved for focusing.

### FIELD OF THE INVENTION

The present invention relates to a lens for infrared cameras, and more particularly, to an internal focusing infrared camera lens with a single focal point that is adapted to form a clear image by focusing infrared rays so as to be suitable for applications of infrared ray thermography, surveillance cameras, and the like. The term ‘infrared rays’ used herein refers to radiations including intermediate infrared rays of wavelength ranging from 3000 to 5000 nm and far infrared rays ranging from 8000 to 14000 nm.

### BACKGROUND ART

Medical-purpose or industrial IR sensors and vidicons for transmitted light of wavelength around approximately 10000 nm are dull in light sensitivity. Germanium used in their optical systems has a poorer transmissivity than any other substance used in ordinary optical lenses. Thus, optical systems for such optical pickup devices are required to have an enhanced absorbency index for efficient IR transmission to the sensors and the vidicons with optical components such as lens pieces as small as possible in number that absorb, disperse, and/or reflect infrared rays from the object. In view of dust-proof and drip-proof, the infrared camera lens preferably has a structure that facilitates and ensures an airtight environment within a lens barrel for precise internal focusing.

One example of the prior art infrared camera lens disclosed so far is suitable to use for infrared rays of wavelength band ranging from 8 to 12 μm and attains a preferred optical performance with a reduced ambient noise in the surroundings of an image; the infrared camera lens being comprised of two lens groups, namely, the foremost or first lens group G1 including the first lens piece L1 of a positive meniscus lens with its convex side faced toward the object and the second lens piece L2 of a negative meniscus lens with its concave side faced toward the object, and the second lens group G2 including the third lens piece L3 of a positive meniscus lens with its concave side faced toward the object and the fourth lens piece L4 of a positive meniscus lens with its convex side faced toward the object; and the infrared camera lens satisfying the requirements as follows:

0.12<|Φ1/Φ2|<0.32 (1)

1.3<|f1/fT|<1.9 (2)

where Φ1 and Φ2 are respectively refractive powers of the first and second lens groups G1 and G2, f1 is a focal length of the first lens piece L1, and fT is the focal length of the entire optics (See Patent Document 1 listed below).

Another example of the prior art infrared camera lens is suitable to use especially for infrared rays of wavelength band ranging from 8 to 12 μm, and it is adapted to ensure a sufficient length of back focus equal to the focal length or even longer and also adapted to fulfill a desired optical performance of noise-free marginal rays and a requirement of moderately downsized dimensions of an optical system, still attaining a vignetting factor of 100%; the infrared camera lens being comprised of two lens groups, namely, the foremost or first lens group G1 including the first lens piece L1 of a negative meniscus lens with its convex side faced toward the object and the second lens piece L2 with positive refractive power, and the second lens group G2 including the third lens piece L3 of a positive meniscus lens with its concave side faced toward the object and the fourth lens piece L4 of a positive meniscus lens with its convex side faced toward the object; and the infrared camera lens satisfying the requirements as follows:

1<D4/f<3 (1)

where D4 is a distance over the optical axis from the rear side of the second lens piece L2 closer to the imaging plane to the front side of the third lens piece L3 closer to the object, and f is a focal length of the entire optical system (See Patent Document 2 listed below).

### PATENT DOCUMENT

### Patent Document 1

Official Gazette of Preliminary Publication of Unexamined Japanese Patent Application No. 2005-062559

### Patent Document 2

Official Gazette of Preliminary Publication of Unexamined Japanese Patent Application No. 2005-173346

### SUMMARY OF THE INVENTION

In the infrared camera lens described in Patent Document 1, an airtight environment within a lens barrel is hard to achieve in both the designs where the lens system as a whole is to be moved for focusing and where the first lens piece L1 closest to the object alone is to be moved for focusing, and either is inappropriate in view of dust-proof and drip-proof. In addition, a design to move the second lens group, namely, the lens pieces L3 and L4, for focusing is desirable in ensuring the airtight environment within the lens barrel, but the resultant infrared camera lens has an increase in comatic aberration and field curvature, which leads to a reduction of optical performance. An alternative design where the lens piece L4 alone is to be moved also experiences an increase in comatic aberration and several other types of aberration, which brings about a reduction of optical performance.

As to the infrared camera lens described in Patent Document 2, the airtight environment within the lens barrel is also hard to achieve in both the designs where the lens system as a whole is to be moved for focusing and where the first lens piece L1 closest to the object alone is to be moved for focusing, and thus, either is inappropriate in view of dust-proof and drip-proof. A dust-proof and drip-proof model could be implemented although it is unavoidable that a barrel design becomes more complicated and a lens diameter becomes larger. An additional design to move the second lens group, namely, the lens pieces L3 and L4 for focusing is desirable in ensuring an airtight environment within the barrel, but the resultant infrared camera lens has an increase in comatic aberration and field curvature, which leads to a reduction of optical performance. An alternative design where the lens piece L4 alone is to be moved for focusing also experiences an increase in comatic aberration and several other types of aberration, which brings about a reduction of optical performance.

### Object of the Invention

The present invention is made to overcome the aforementioned problems in the prior art examples of the infrared camera lens, and accordingly, it is an object of the present invention to provide an infrared camera lens that is simple in lens configuration and has lens pieces that include only spherical surfaces but no aspheric surfaces.

It is another object of the present invention to provide an infrared camera lens of a design that facilitates and implements an airtight environment within the lens barrel because the foremost or first lens closest to the object stays still during focusing, and the entire length of the lens system is unchanged for focusing.

It is further another object of the present invention to provide an infrared camera lens in which image deterioration accompanying the focusing is reduced.

The present invention is a lens suitable for infrared cameras, comprising the foremost or first single spherical lens piece of positive refractivity, the succeeding or second single spherical lens piece of negative refractivity, and the third single spherical lens piece of positive refractivity. At least the second single spherical lens piece of negative refractivity or the third single spherical lens piece of positive refractivity is to be moved for focusing.

In accordance with the present invention, a lens suitable for infrared cameras can be implemented with a simplified lens configuration and with lens components having only spherical surfaces but no aspheric surfaces.

Further, in accordance with the present invention, a lens suitable for infrared cameras can be implemented with a design that facilitates an airtight environment within the lens barrel because the foremost or first lens closest to the object stays still during focusing, and the entire length of the lens is unchanged for focusing.

Furthermore, in accordance with the present invention, a lens suitable for infrared cameras can be implemented with a reduced image deterioration accompanying the focusing.

The present invention can be described in various aspects as follows.

### (Aspect 1)

In the infrared camera lens of the present invention, the second foremost single spherical lens piece of negative refractivity alone is to be moved for focusing.

This is advantageous in that the infrared camera lens permits its lens barrel to be perfectly hermetically sealed.

### (Aspects 2)

In the infrared camera lens of the present invention, the third single spherical lens piece of positive refractivity alone is to be moved for focusing.

This is advantageous in that the third single spherical lens piece is moved by a reduced displacement for focusing.

### (Aspects 3)

In the infrared camera lens of the present invention, the infrared camera lens meets the requirement as defined in the following formula:

0.5≦f/f1≦0.7 (1)

where f is a focal length of the entire lens system, and f1 is the focal length of the foremost or first single spherical lens piece of positive refractivity.

When it satisfies the requirement as defined in the formula (1), the infrared camera lens advantageously facilitates a reduction of comatic aberration.

### (Aspects 4)

In the infrared camera lens of the present invention, the second single lens piece of negative refractivity is to be moved for focusing, and the infrared camera lens meets the requirement as defined in the following formula:

0.06≦|m2/f1|≦0.22 (2)

where m2 is a displacement of the second single spherical lens of negative refractivity in the event of the object distance ranging from infinity to 1 m, and f1 is a focal distance of the foremost or first single spherical lens piece of positive refractivity.

When it satisfies the requirement as in the formula (2), the infrared camera lens can advantageously be reduced in the entire lens dimensions and facilitates a reduction in field curvature.

### (Aspects 5)

In the infrared camera lens of the present invention, the third single spherical lens piece of negative refractivity is moved for focusing, and the infrared camera lens satisfies the requirement as defined in the following formula:

0.01≦|m3/f1|≦0.045 (3)

where m3 is a displacement of the third single spherical lens of positive refractivity in the event of the object distance ranging from infinity to 1 m, and f1 is a focal distance of the foremost or first single spherical lens piece of positive refractivity.

When it satisfies the requirement as in the formula (3), the infrared camera lens can advantageously be reduced in the entire lens dimensions and facilitates a reduction in field curvature.

### (Aspect 6)

In the infrared camera lens of the present invention, all the component lens pieces are made of germanium.

Fabricating all the component lens pieces of the single substance is advantageous in that the manufacturing cost of the infrared camera lens can be reduced, and the lens pieces exhibit absorption coefficient as low as it is inherent in the substance.

### BRIEF DESCRIPTION OF THE DRAWINGS

FIG. 1 is a cross-sectional view illustrating a first embodiment of an infrared camera lens according to the present invention imaging in focus an object at a point infinity and an object 1-meter ahead.

FIG. 2 is graphs illustrating spherical aberration in the first embodiment of the infrared camera lens that is imaging in focus at a point infinity.

FIG. 3 is graphs illustrating comatic aberration in the first embodiment of the infrared camera lens that is imaging in focus at a point infinity.

FIG. 4 is graphs illustrating spherical aberration in the first embodiment of the infrared camera lens that is imaging in focus at 1-meter ahead.

FIG. 5 is graphs illustrating comatic aberration in the first embodiment of the infrared camera lens that is imaging in focus at 1-meter ahead.

FIG. 6 is a cross-sectional view illustrating a second embodiment of the infrared camera lens according to the present invention imaging in focus the object at a point infinity and the object 1-meter ahead.

FIG. 7 is graphs illustrating spherical aberration in the second embodiment of the infrared camera lens that is imaging in focus at a point infinity.

FIG. 8 is graphs illustrating comatic aberration in the second embodiment of the infrared camera lens that is imaging in focus at a point infinity.

FIG. 9 is graphs illustrating spherical aberration in the second embodiment of the infrared camera lens that is imaging in focus at 1-meter ahead.

FIG. 10 is graphs illustrating comatic aberration in the second embodiment of the infrared camera lens that is imaging in focus at 1-meter ahead.

FIG. 11 is a cross-sectional view illustrating a third embodiment of an infrared camera lens according to the present invention imaging in focus the object at a point infinity and the object 1-meter ahead.

FIG. 12 is graphs illustrating spherical aberration in the third embodiment of the infrared camera lens that is imaging in focus at a point infinity.

FIG. 13 is graphs illustrating comatic aberration in the third embodiment of the infrared camera lens that is imaging in focus at a point infinity.

FIG. 14 is graphs illustrating spherical aberration in the third embodiment of the infrared camera lens that is imaging in focus at 1-meter ahead.

FIG. 15 is graphs illustrating comatic aberration in the third embodiment of the infrared camera lens that is imaging in focus at 1-meter ahead.

FIG. 16 is a cross-sectional view illustrating a fourth embodiment of an infrared camera lens according to the present invention imaging in focus the object at a point infinity and the object 1-meter ahead.

FIG. 17 is graphs illustrating spherical aberration in the fourth embodiment of the infrared camera lens that is imaging in focus at a point infinity.

FIG. 18 is graphs illustrating comatic aberration in the fourth embodiment of the infrared camera lens that is imaging in focus at a point infinity.

FIG. 19 is graphs illustrating spherical aberration in the fourth embodiment of the infrared camera lens that is imaging in focus at 1-meter ahead.

FIG. 20 is graphs illustrating comatic aberration in the fourth embodiment of the infrared camera lens that is imaging in focus at 1-meter ahead.

FIG. 21 is a cross-sectional view illustrating a fifth embodiment of an infrared camera lens according to the present invention imaging in focus the object at a point infinity and the object 1-meter ahead.

FIG. 22 is graphs illustrating spherical aberration in the fifth embodiment of the infrared camera lens that is imaging in focus at a point infinity.

FIG. 23 is graphs illustrating comatic aberration in the fifth embodiment of the infrared camera lens that is imaging in focus at a point infinity.

FIG. 24 is graphs illustrating spherical aberration in the fifth embodiment of the infrared camera lens that is imaging in focus at 1-meter ahead.

FIG. 25 is graphs illustrating comatic aberration in the fifth embodiment of the infrared camera lens that is imaging in focus at 1-meter ahead.

FIG. 26 a cross-sectional view illustrating a sixth embodiment of an infrared camera lens according to the present invention imaging in focus the object at a point infinity and the object 1-meter ahead.

FIG. 27 is graphs illustrating spherical aberration in the sixth embodiment of the infrared camera lens that is imaging in focus at a point infinity.

FIG. 28 is graphs illustrating comatic aberration in the sixth embodiment of the infrared camera lens that is imaging in focus at a point infinity.

FIG. 29 is graphs illustrating spherical aberration in the sixth embodiment of the infrared camera lens that is imaging in focus at 1-meter ahead.

FIG. 30 is graphs illustrating comatic aberration in the sixth embodiment of the infrared camera lens that is imaging in focus at 1-meter ahead.

FIG. 31 is a cross-sectional view illustrating a seventh embodiment of an infrared camera lens according to the present invention imaging in focus the object at a point infinity and the object 1-meter ahead.

FIG. 32 is graphs illustrating spherical aberration in the seventh embodiment of the infrared camera lens that is imaging in focus at a point infinity.

FIG. 33 is graphs illustrating comatic aberration in the seventh embodiment of the infrared camera lens that is imaging in focus at a point infinity.

FIG. 34 is graphs illustrating spherical aberration in the seventh embodiment of the infrared camera lens that is imaging in focus at 1-meter ahead.

FIG. 35 is graphs illustrating comatic aberration in the seventh embodiment of the infrared camera lens that is imaging in focus at 1-meter ahead.

FIG. 36 is a cross-sectional view illustrating a eighth embodiment of an infrared camera lens according to the present invention imaging in focus the object at a point infinity and the object 1-meter ahead.

FIG. 37 is graphs illustrating spherical aberration in the eighth embodiment of the infrared camera lens that is imaging in focus at a point infinity.

FIG. 38 is graphs illustrating comatic aberration in the eighth embodiment of the infrared camera lens that is imaging in focus at a point infinity.

FIG. 39 is graphs illustrating spherical aberration in the eighth embodiment of the infrared camera lens that is imaging in focus at 1-meter ahead.

FIG. 40 is graphs illustrating comatic aberration in the eighth embodiment of the infrared camera lens that is imaging in focus at 1-meter ahead.

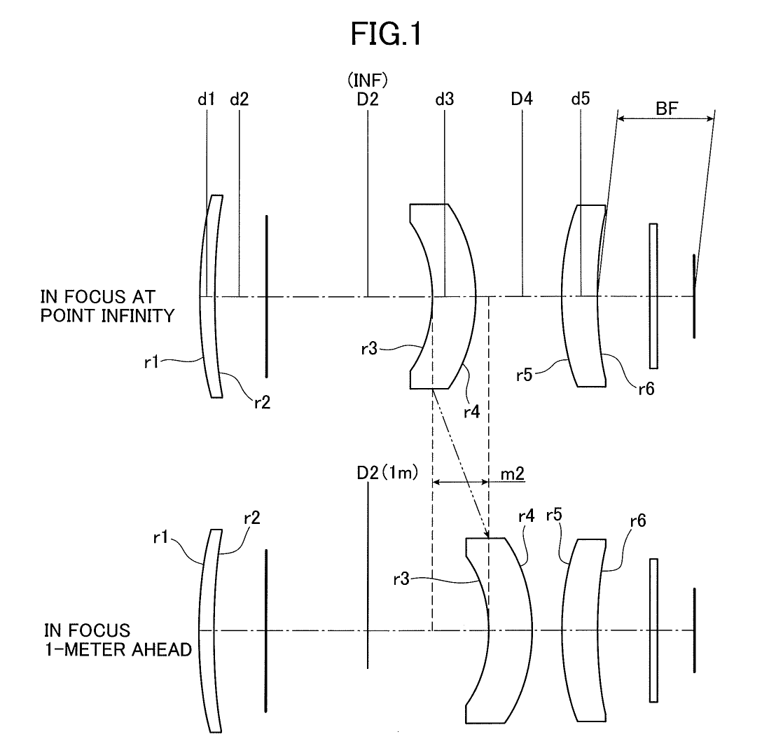

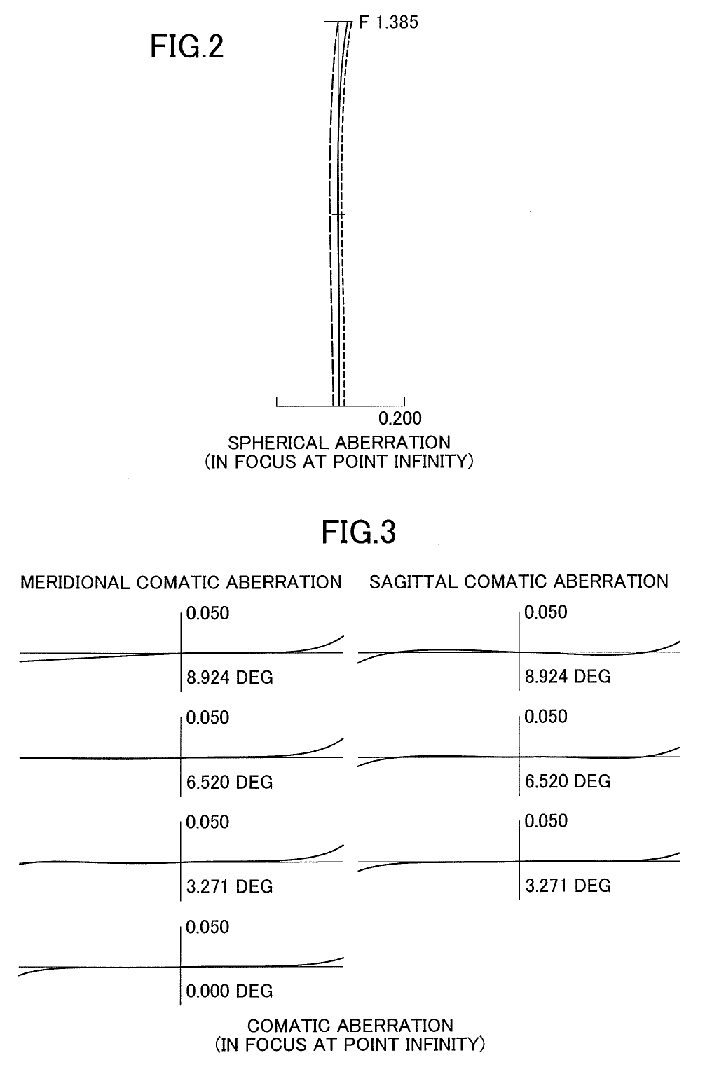

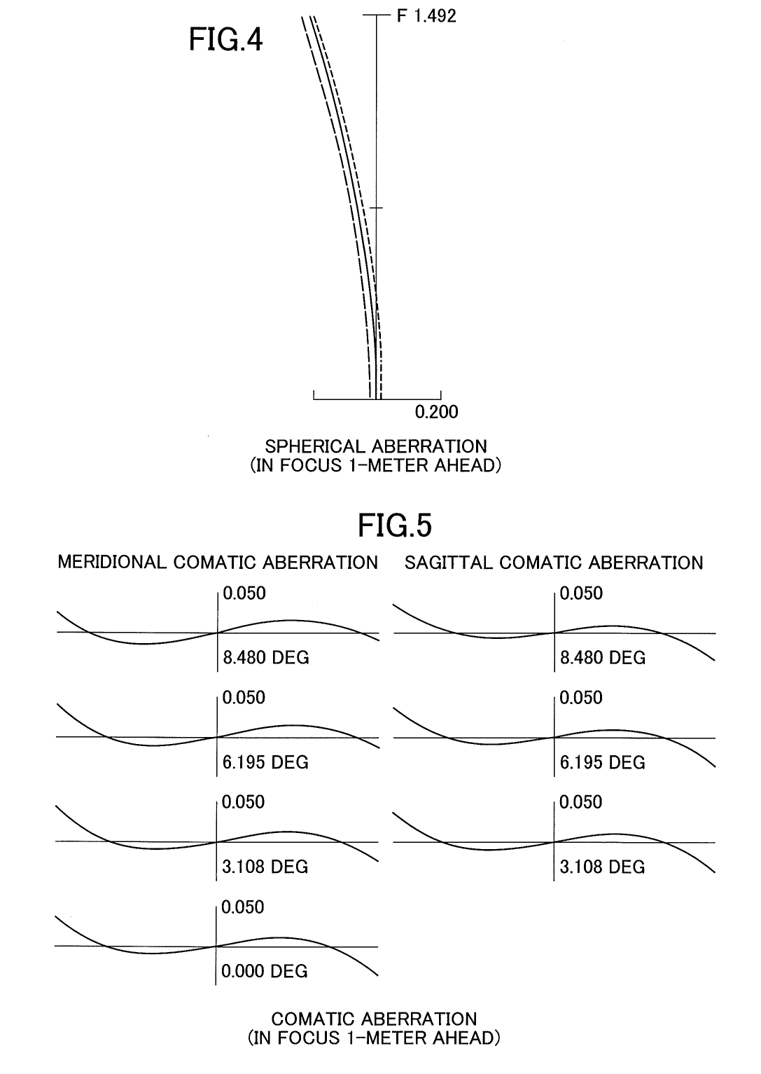

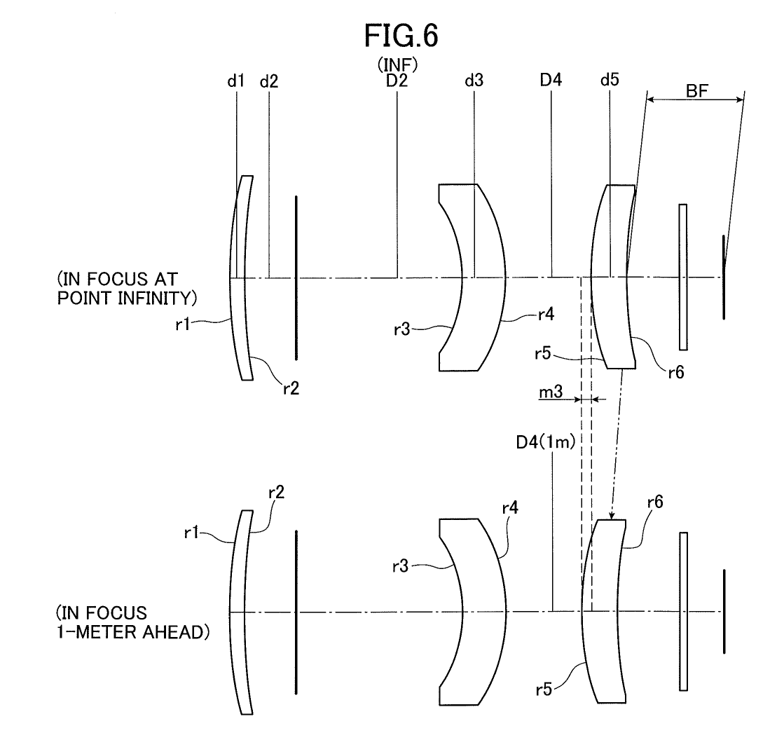

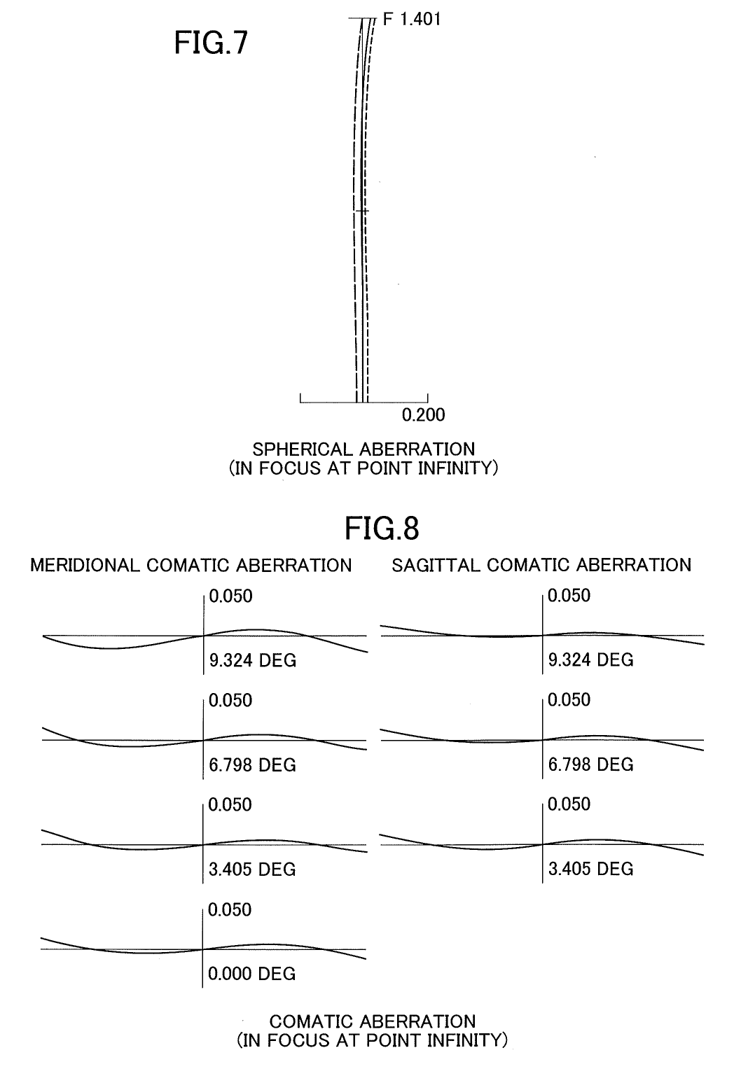

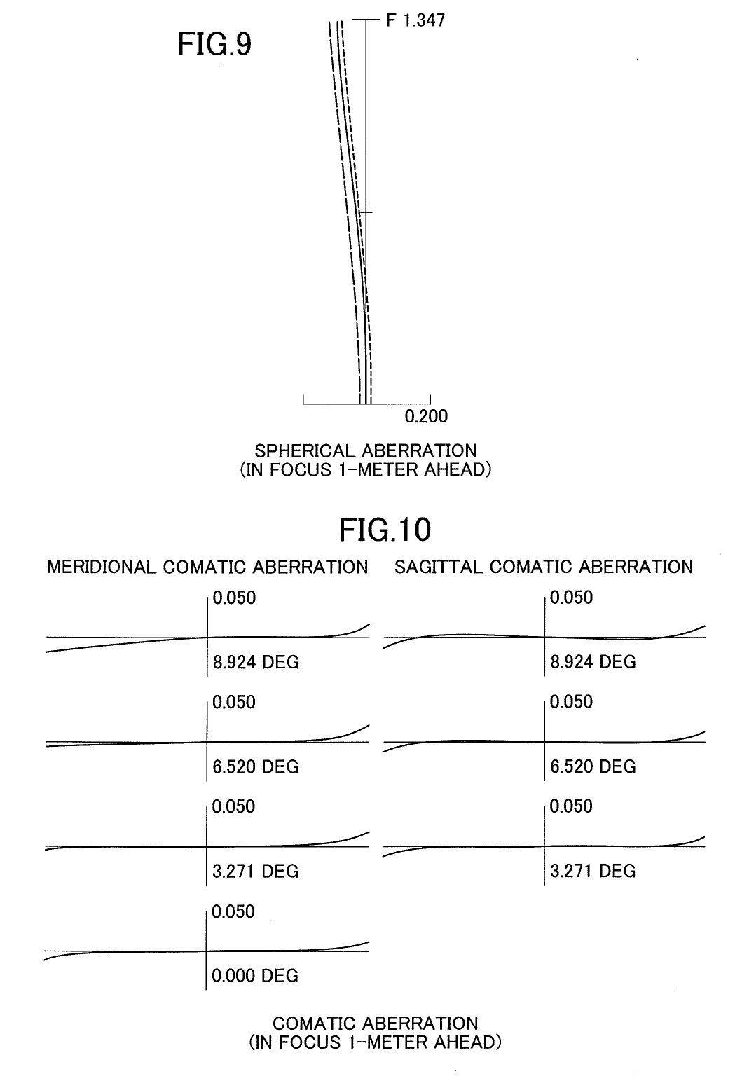

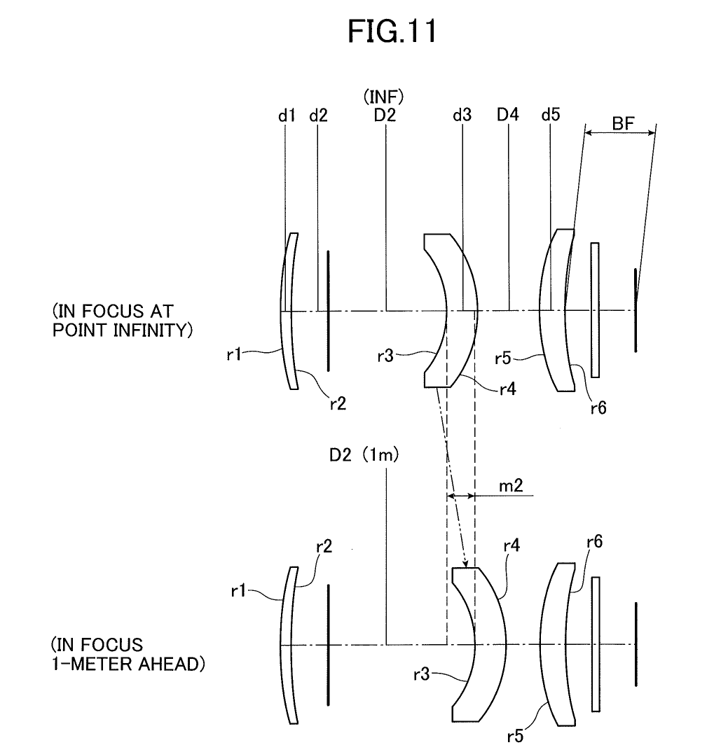

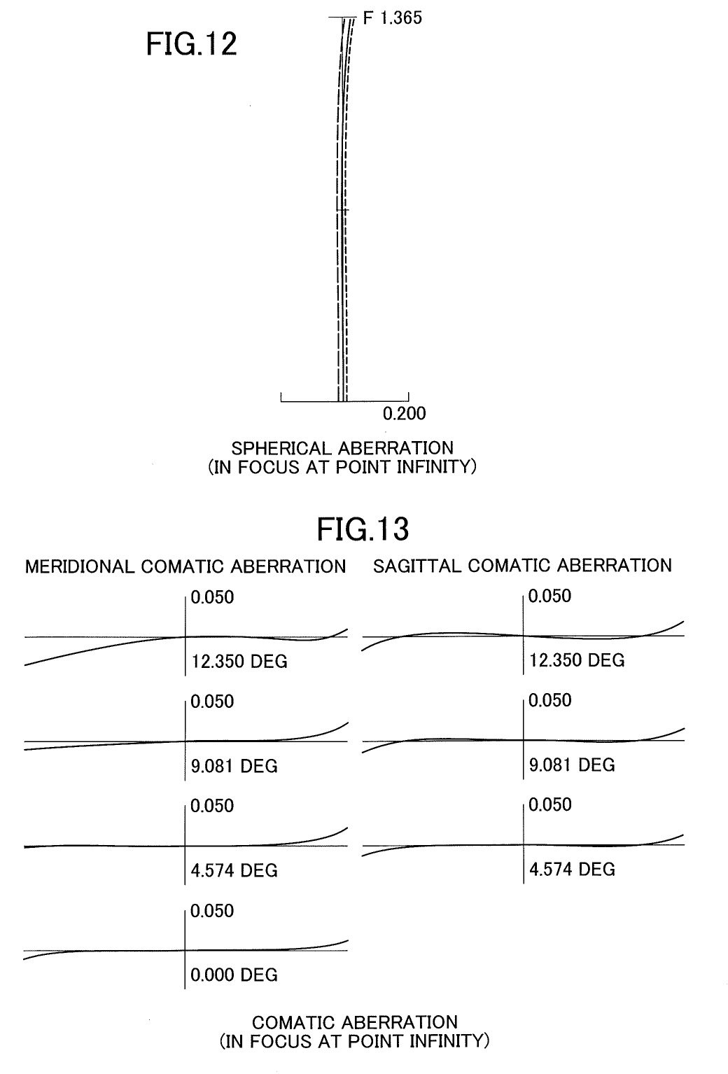

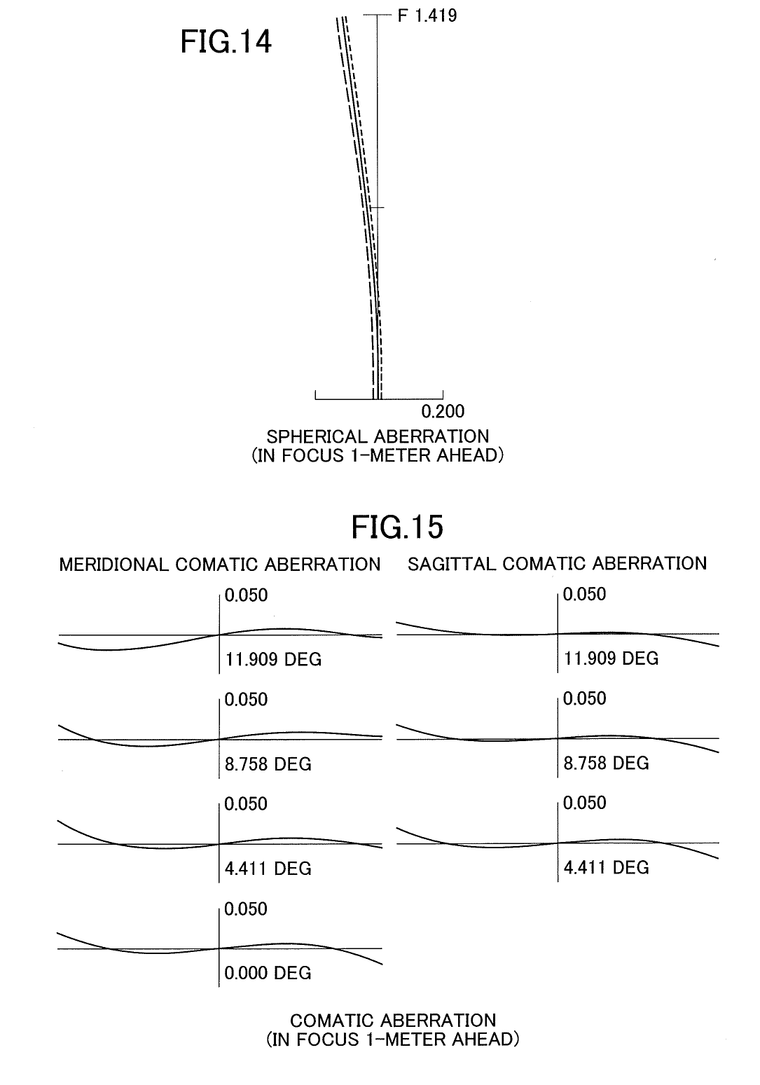

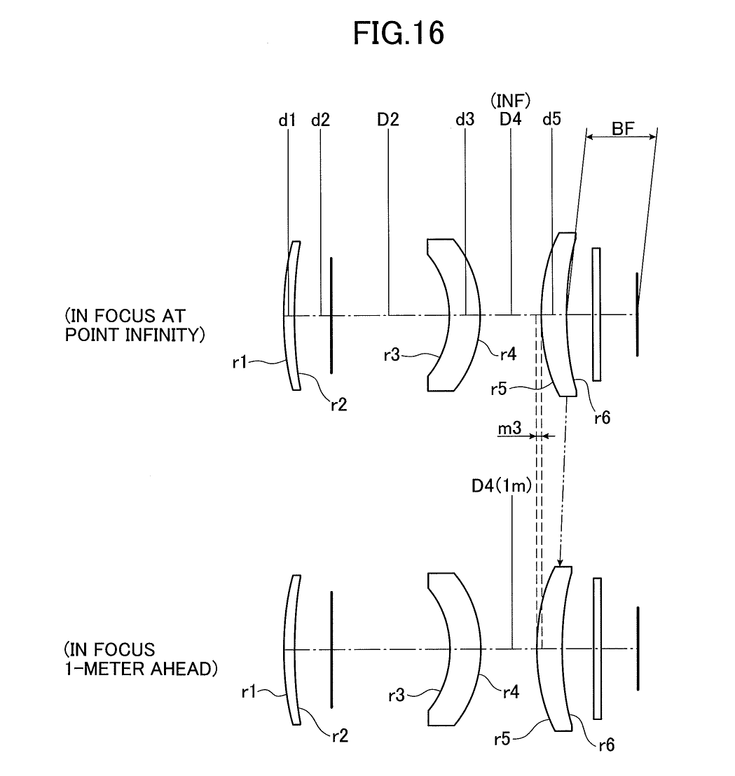

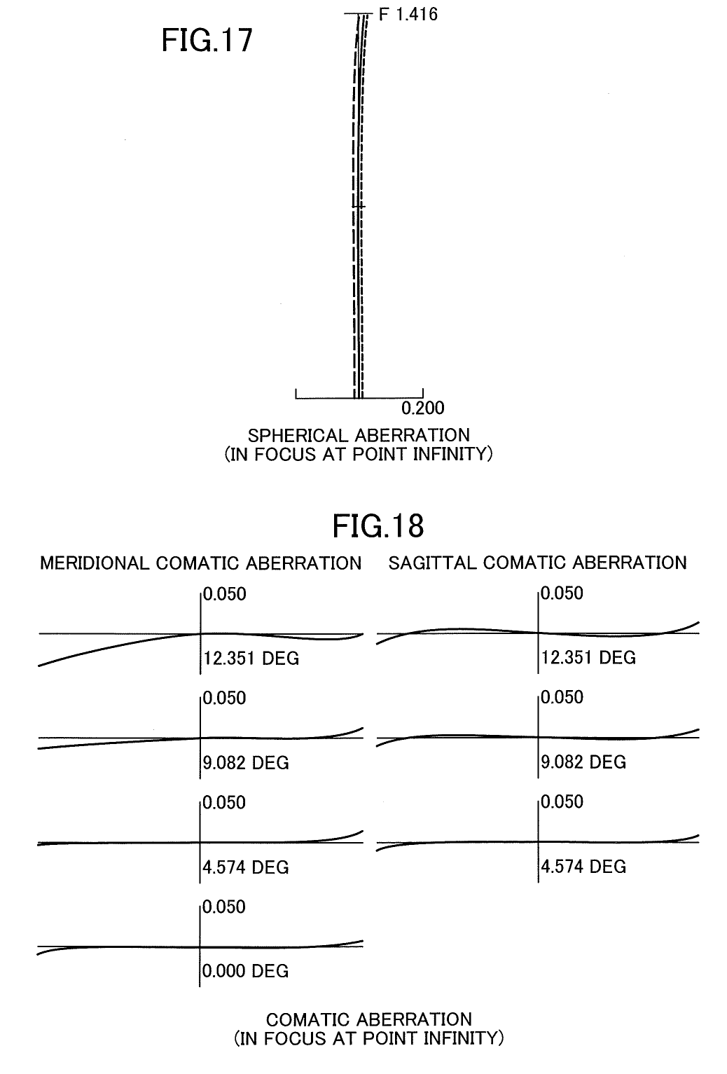

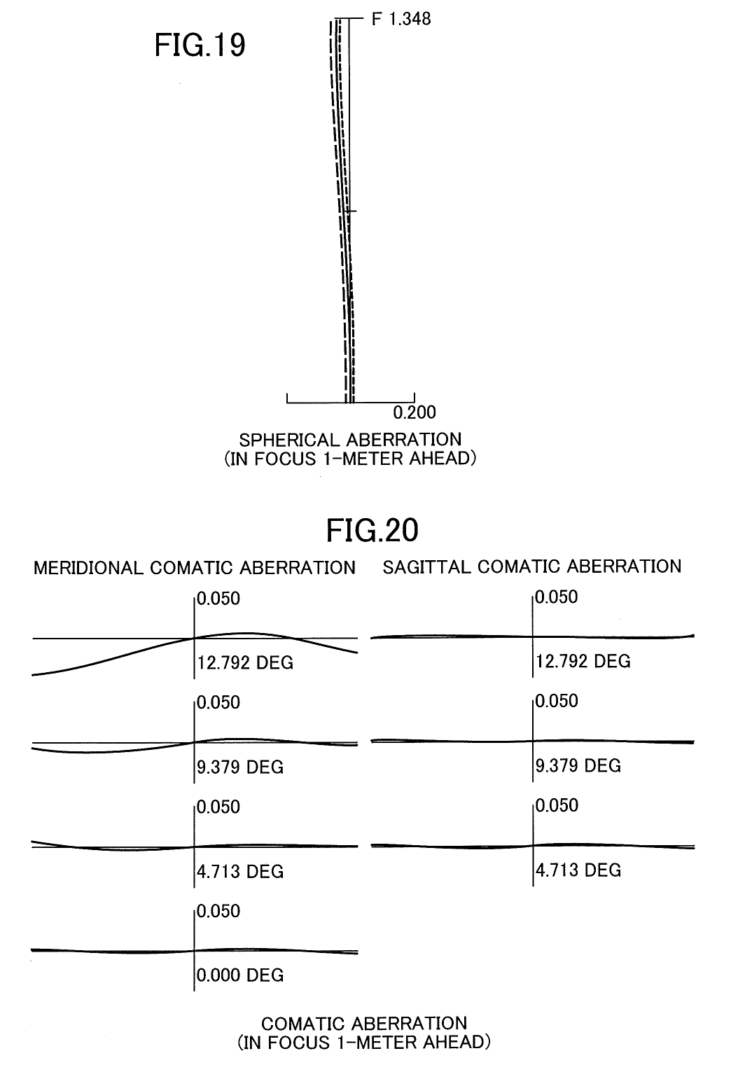

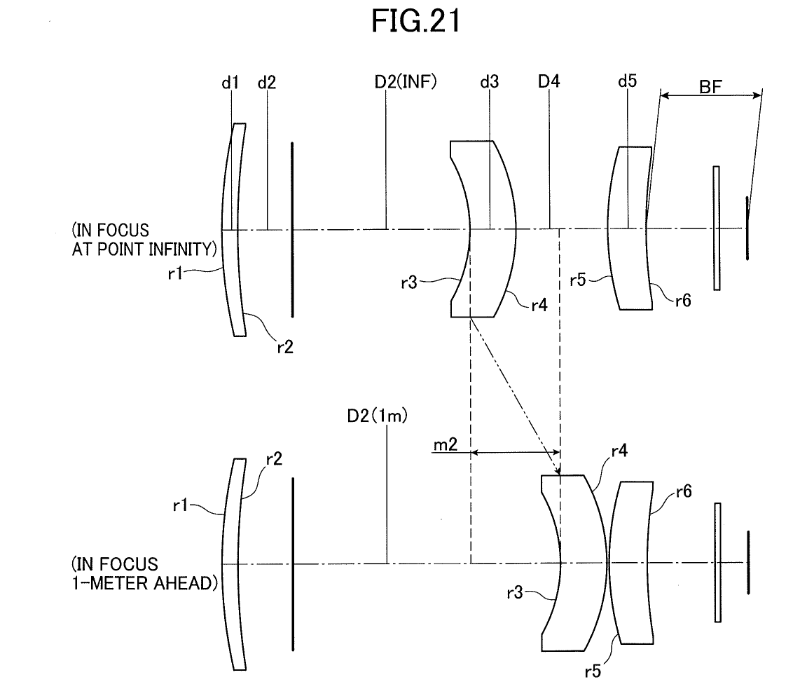

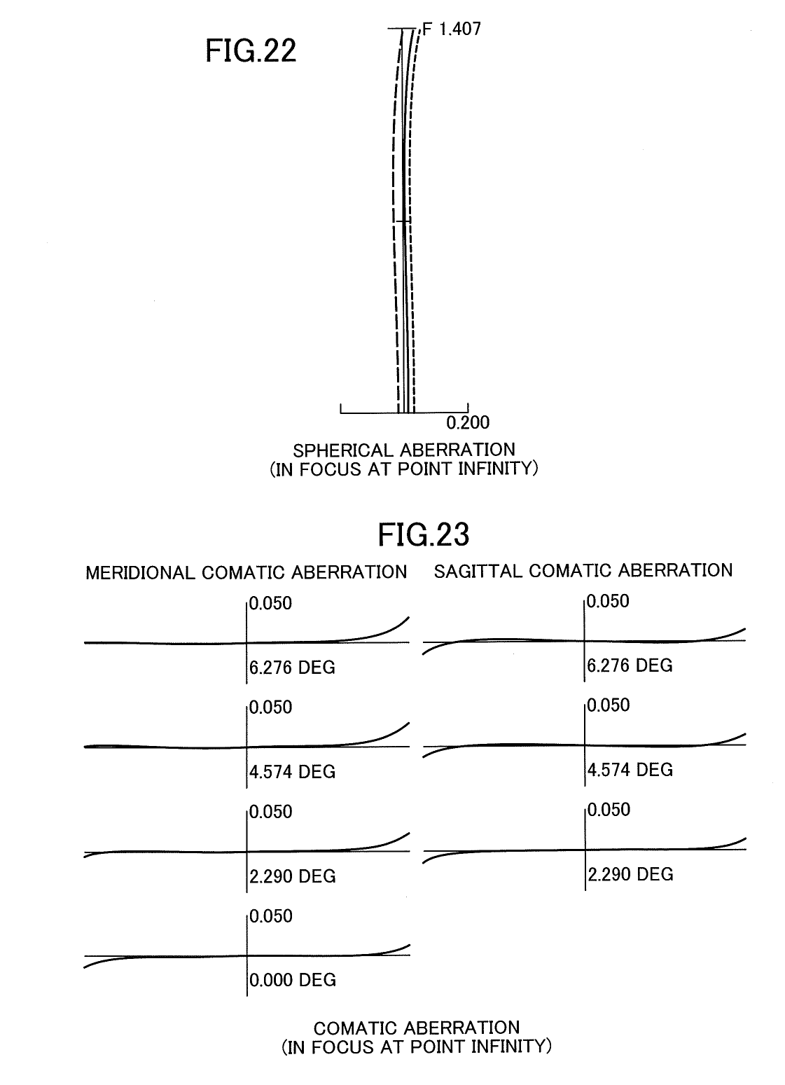

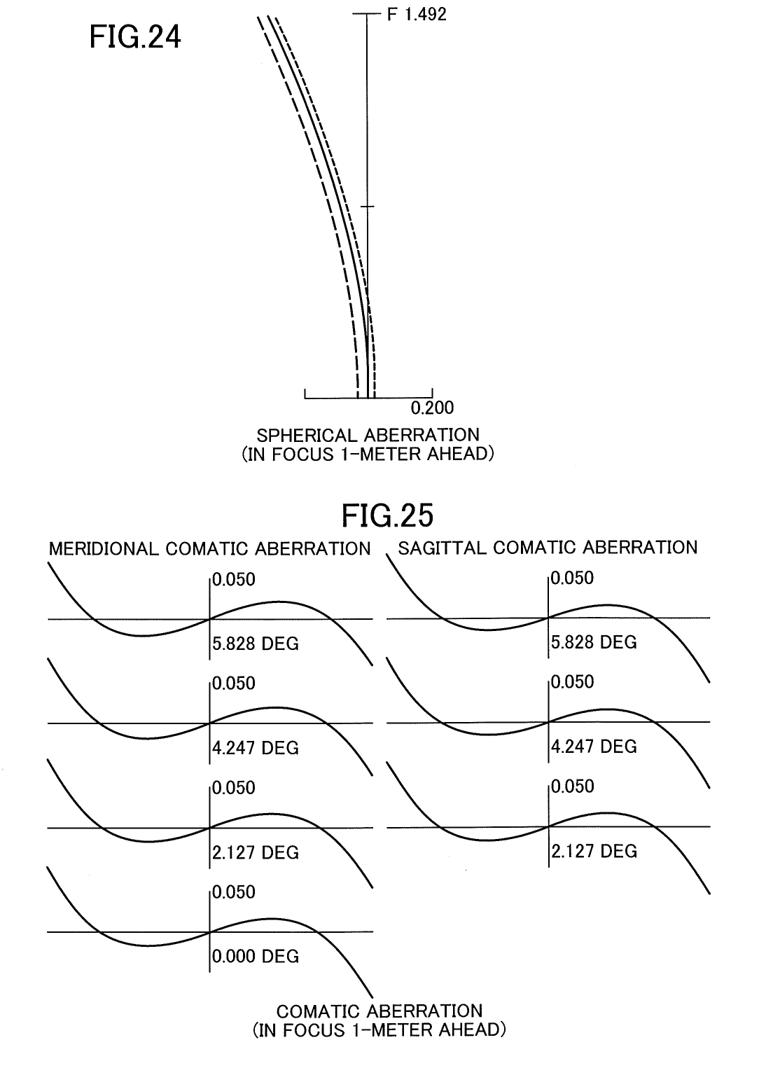

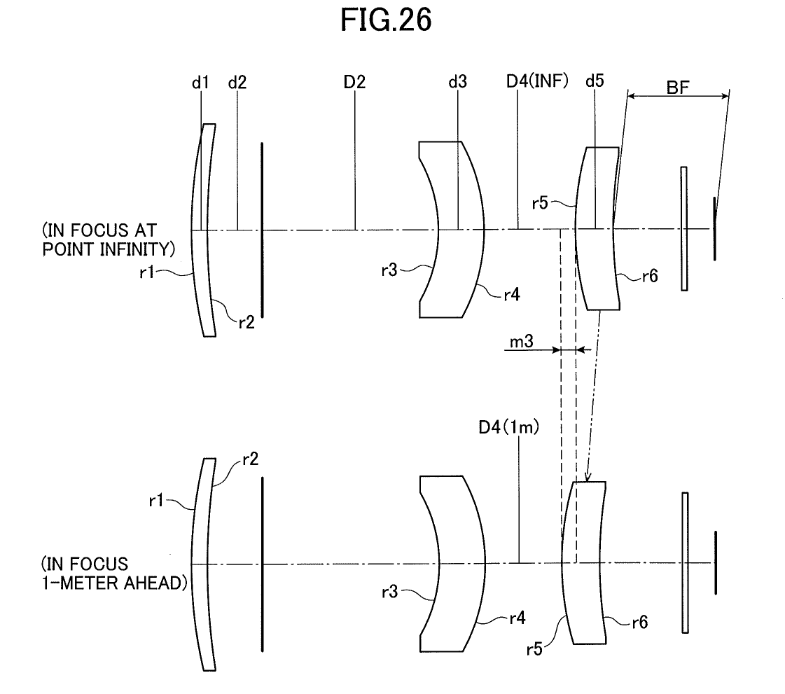

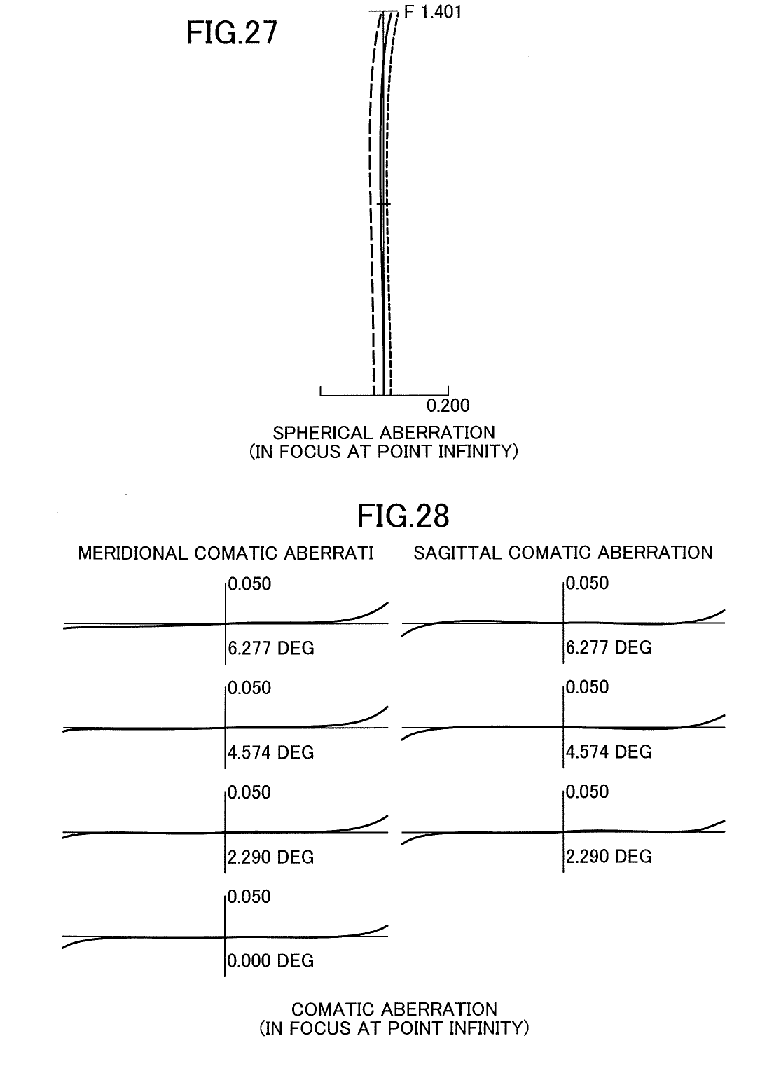

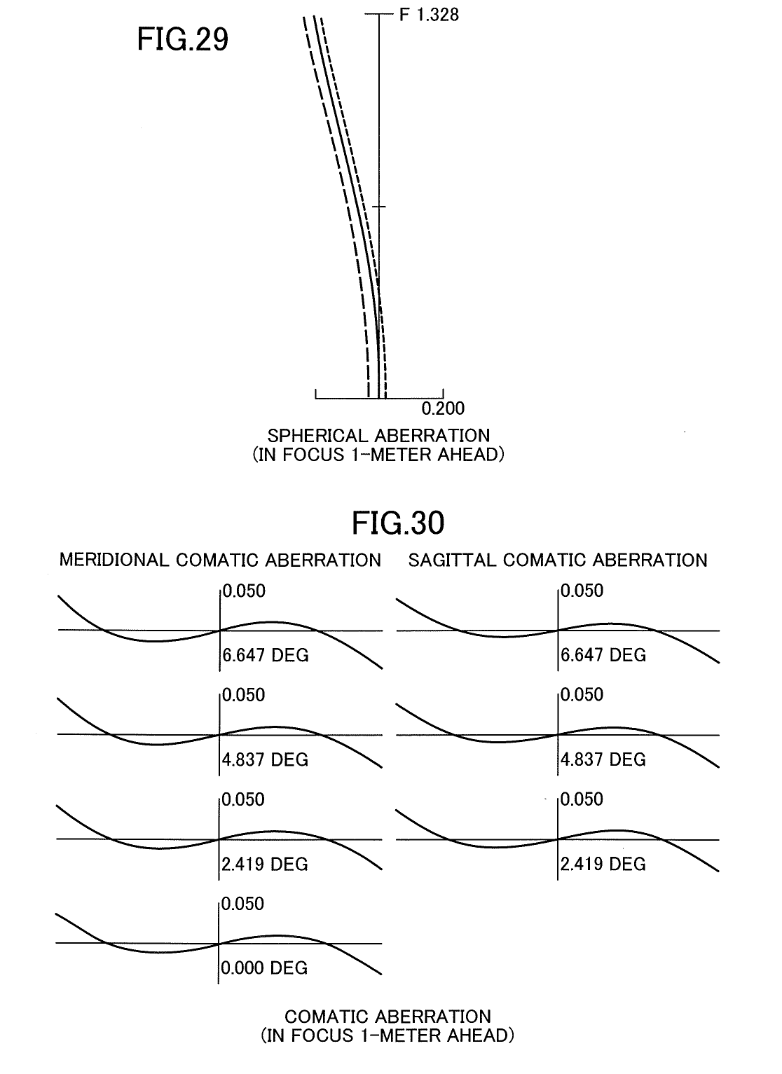

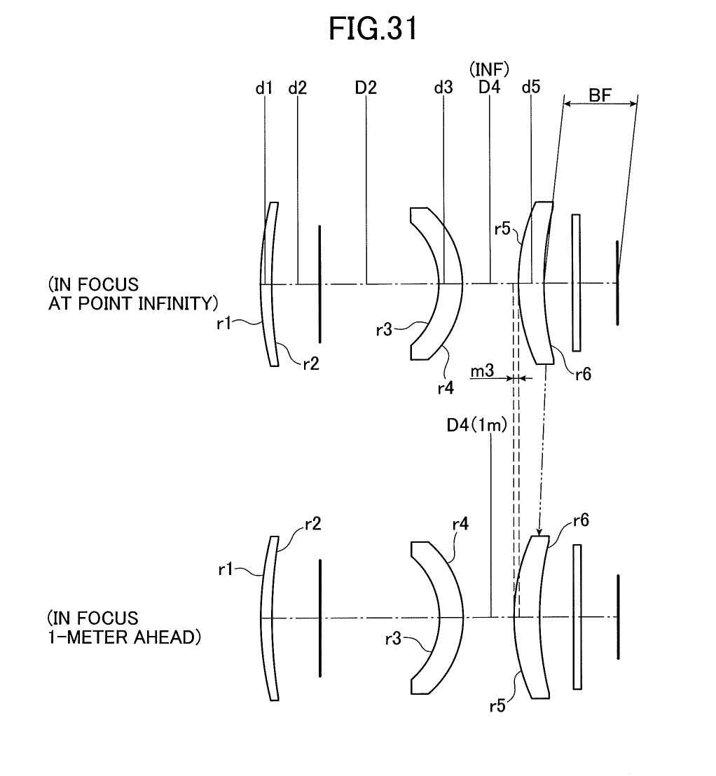

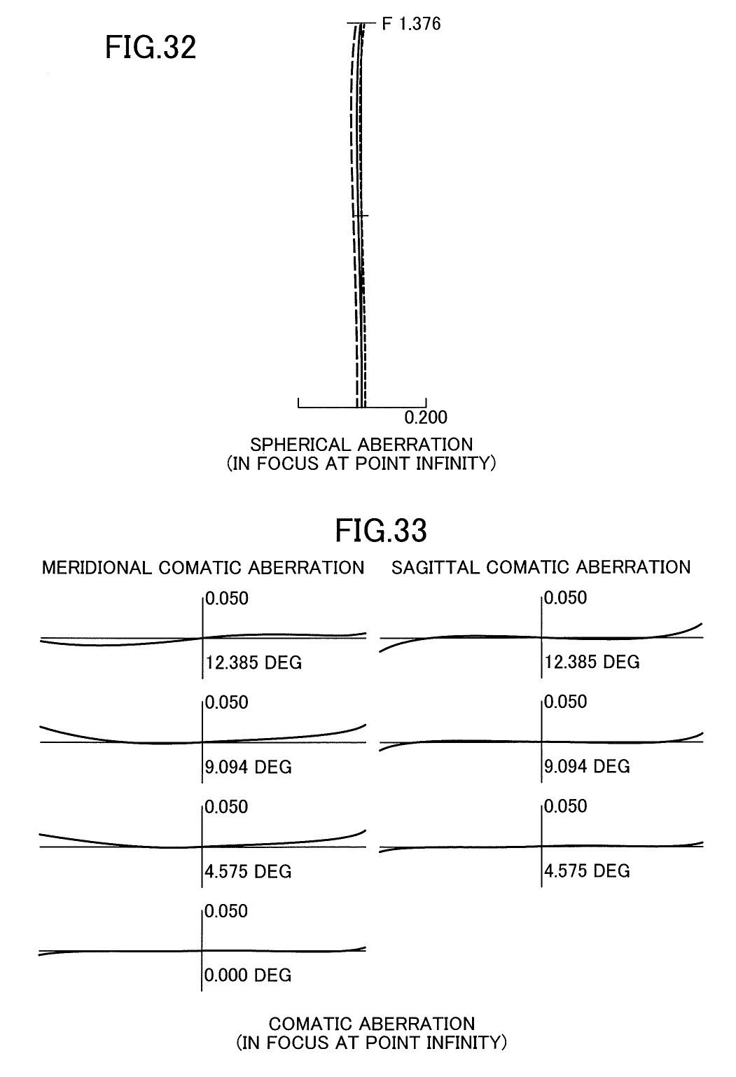

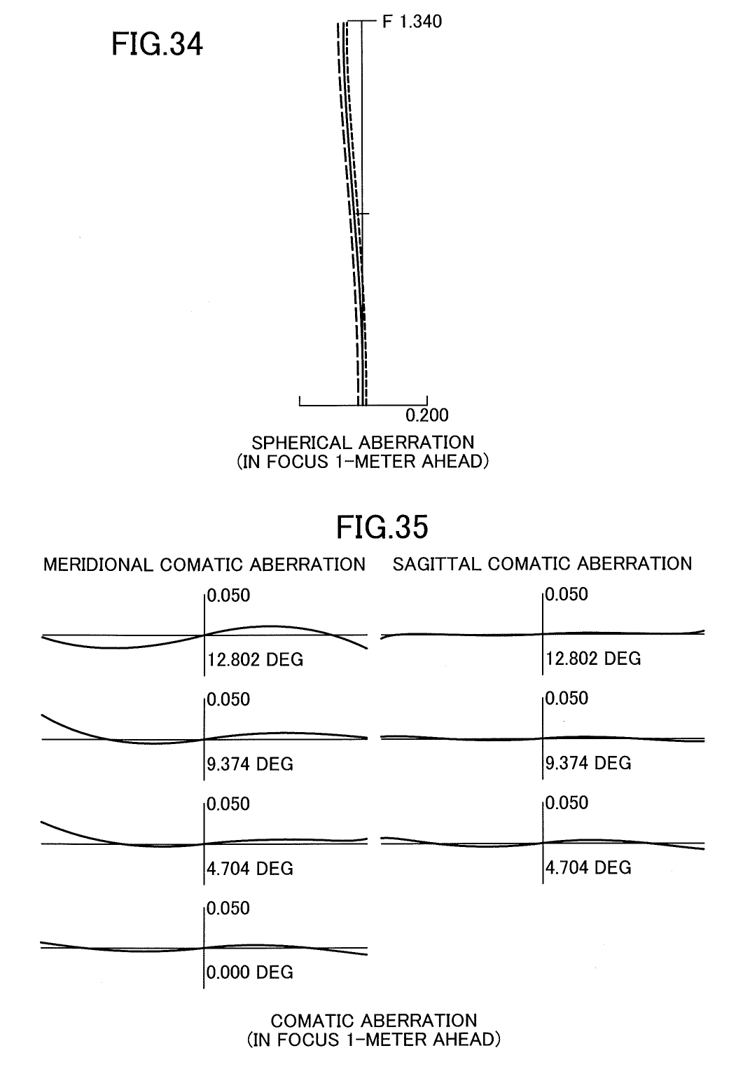

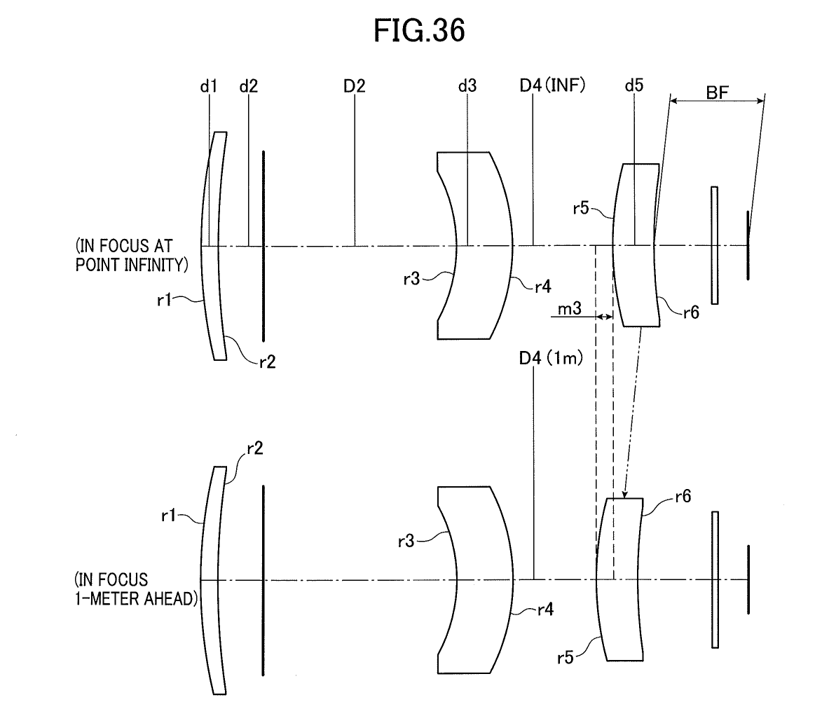

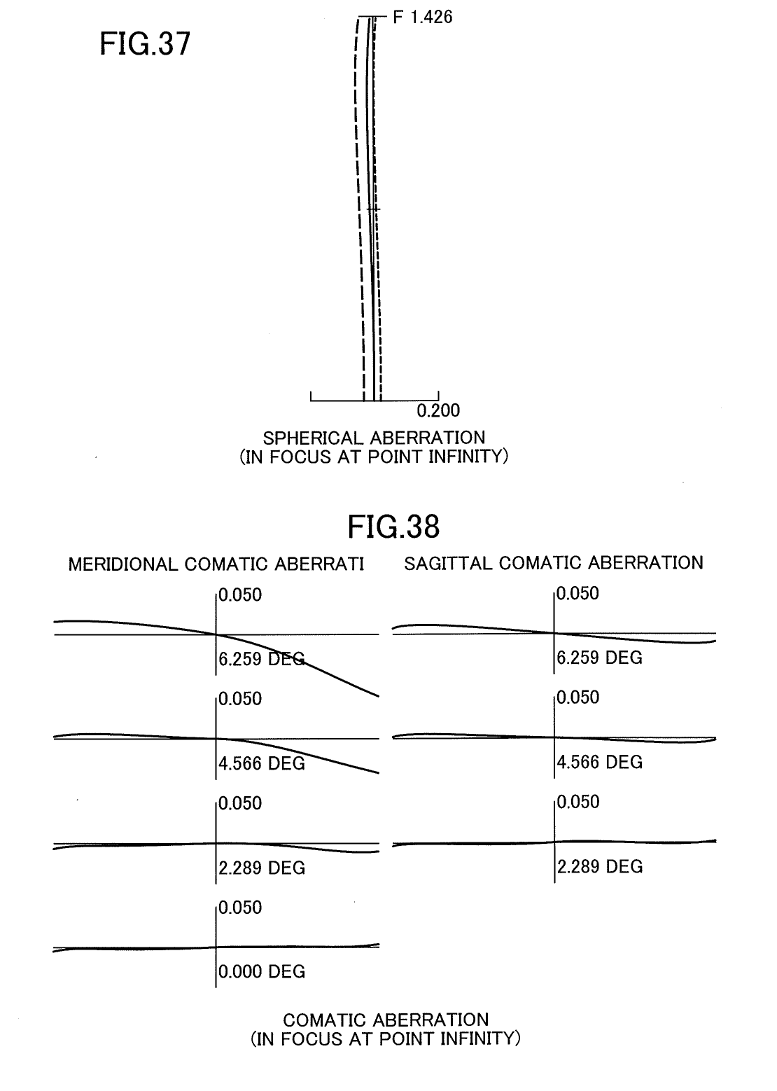

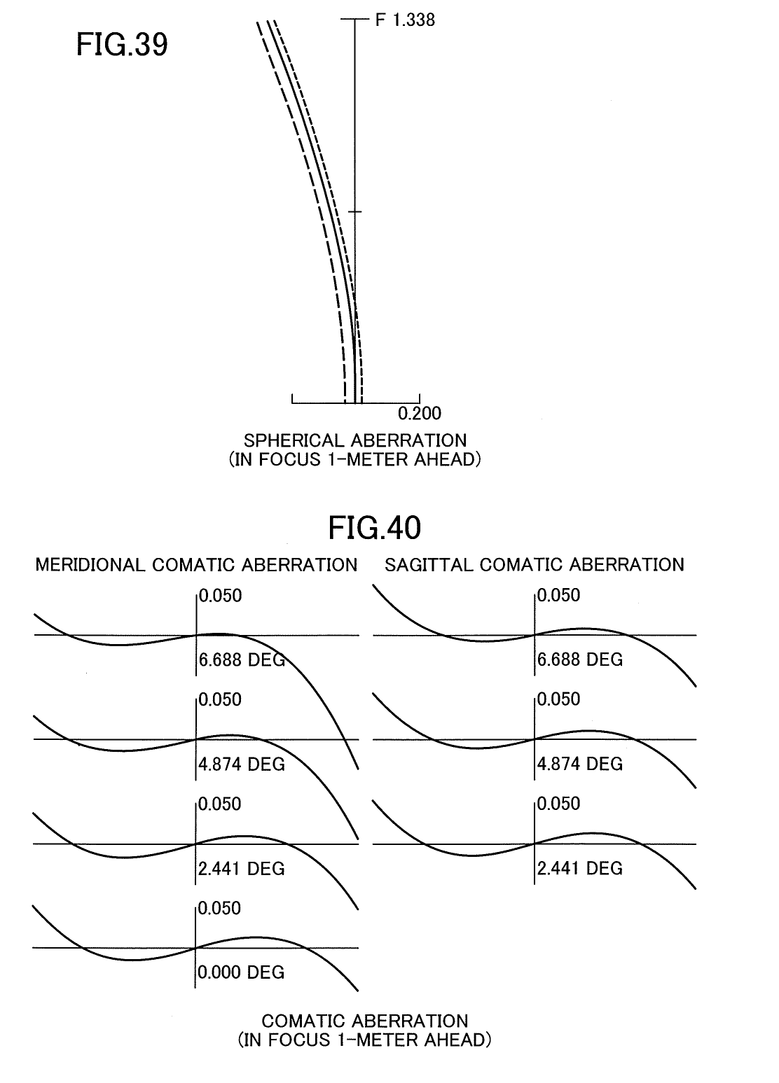

### DETAILED DESCRIPTION OF THE PREFERRED EMBODIMENT

An infrared camera lens according to the present invention will be detailed below in conjunction with embodiments, providing their respective lens property data.

### Embodiment 1

The following data set is for an embodiment in which the second foremost lens piece is to be moved for focusing.

| | |
|---|---|
| # | Surface Number |
| R | Radius of Curvature |
| d | Lens Thickness or Distance between the Adjacent Surfaces |
| r | Lens Radius |
| n | Refractive Index of Lens Substance |
| f | Focal Length |

| # | | R | d | r | n | f | |
|---|---|---|---|---|---|---|---|
| r1 | d1 | 58.71 | 2.02 | 13.7 | Ge(4.0032) | 57.98 | f1 |
| r2 | d2 | 86.29 | 6.94 | 13.4 | | | |
| (Aperture Stop) | | | D2 | 10.9 | | | |
| r3 | d3 | −18.13 | 5.8 | 10 | Ge(4.0032) | −431.69 | f2 |
| r4 | D4 | −22.8 | D4 | 12.4 | | | |
| r5 | d5 | 36 | 4.8 | 12.2 | Ge(4.0032) | 27.45 | f3 |
| r6 | BF | 57.52 | (BF) | 11.2 | | | |

| | |
|---|---|
| Focal Length | f = 35 |
| Entire Length | 66.46 mm |

| | | ½Angle | | | | |
|---|---|---|---|---|---|---|
| Overall Distance | F/No | of View ω | D2 | D4 | BF | m2 |
| At Point Infinity | 1.39 | 8.92 | 22.3 | 11.55 | 13.05 | 7.52 |
| 1-Meter Ahead | 1.49 | 8.48 | 29.82 | 4.03 | 13.05 | |

(Value Given to the Formula):

| | | |
|---|---|---|
| Formula (1) | 0.5 ≦ f/f1 ≦ 0.7 | f/f1 = 0.60 |
| Formula (2) | 0.06 ≦ \| m2/f1 \| ≦ 0.22 | \| m2/f1 \| = 0.13 |

### Embodiment 2

The following data set is for another embodiment in which the third lens piece is to be moved for focusing.

| | |
|---|---|
| # | Surface Number |
| R | Radius of Curvature |
| d | Lens Thickness or Distance between the Adjacent Surfaces |
| r | Lens Radius |
| n | Refractive Index of Lens Substance |
| f | Focal Length |

| # | | R | d | r | n | f | |
|---|---|---|---|---|---|---|---|
| r1 | d1 | 58 | 2 | 13.7 | Ge(4.0032) | 58.01 | f1 |
| r2 | d2 | 84.7 | 6.94 | 13.4 | | | |
| (Aperture Stop) | | | D2 | 10.9 | | | |
| r3 | d3 | −18.13 | 5.8 | 10.1 | Ge(4.0032) | −431.69 | f2 |
| r4 | D4 | −22.8 | D4 | 12.5 | | | |
| r5 | d5 | 36 | 4.8 | 12.3 | Ge(4.0032) | 27.45 | f3 |
| r6 | BF | 57.52 | (BF) | 11.3 | | | |

| | |
|---|---|
| Focal Length | f = 35 |
| Entire Length | 66.45 mm |

| | | ½Angle | | | | |
|---|---|---|---|---|---|---|
| Overall Distance | F/No | of View ω | D2 | D4 | BF | m3 |
| At Point Infinity | 1.4 | 8.92 | 22.3 | 11.55 | 13.06 | −1.35 |
| At 1-Meter Ahead | 1.35 | 8.32 | 22.3 | 10.2 | 14.41 | |

(Value Given to the Formula):

| | | |
|---|---|---|
| Formula (1) | 0.5 ≦ f/f1 ≦ 0.7 | f/f1 = 0.60 |
| Formula (2) | 0.01 ≦ \| m3/f1 \| ≦ 0.045 | \| m3/f1 \| = 0.023 |

### Embodiment 3

The following data set is for still another embodiment in which the second foremost lens piece is to be moved for focusing.

| | |
|---|---|
| # | Surface Number |
| R | Radius of Curvature |
| d | Lens Thickness or Distance between the Adjacent Surfaces |
| r | Lens Radius |
| n | Refractive Index of Lens Substance |
| f | Focal Length |

| # | | R | d | r | n | f | |
|---|---|---|---|---|---|---|---|
| r1 | d1 | 41.94 | 1.44 | 10.5 | Ge(4.0032) | 41.41 | f1 |
| r2 | d2 | 61.65 | 4.96 | 10.3 | | | |
| (Aperture Stop) | | | D2 | 8 | | | |
| r3 | d3 | −12.95 | 4.14 | 8.3 | Ge(4.0032) | −299.96 | f2 |
| r4 | D4 | −16.29 | D4 | 10.3 | | | |
| r5 | d5 | 25.72 | 3.43 | 10.9 | Ge(4.0032) | 19.61 | f3 |
| r6 | BF | 41.09 | (BF) | 11.1 | | | |

| | |
|---|---|
| Focal Length | f = 25 |
| Entire Length | 47.7 mm |

| | | ½Angle | | | | |
|---|---|---|---|---|---|---|
| Overall Distance | F/No | of View ω | D2 | D4 | BF | m2 |
| At Point Infinity | 1.37 | 12.35 | 15.93 | 8.26 | 9.54 | 3.57 |
| At 1-Meter Ahead | 1.42 | 11.91 | 19.68 | 4.51 | 9.54 | |

(Value Given to the Formula):

| | | |
|---|---|---|
| Formula (1) | 0.5 ≦ f/f1 ≦ 0.7 | f/f1 = 0.60 |
| Formula (2) | 0.06 ≦ \| m2/f1 \| ≦ 0.22 | \| m2/f1 \| = 0.09 |

### Embodiment 4

The following data set is for further another embodiment in which the third lens piece is to be moved for focusing.

| | |
|---|---|
| # | Surface Number |
| R | Radius of Curvature |
| d | Lens Thickness or Distance between the Adjacent Surfaces |
| r | Lens Radius |
| n | Refractive Index of Lens Substance |
| f | Focal Length |

| # | | R | d | r | n | f | |
|---|---|---|---|---|---|---|---|
| r1 | d1 | 41.44 | 1.43 | 10 | Ge(4.0032) | 41.45 | f1 |
| r2 | d2 | 60.51 | 4.96 | 9.7 | | | |
| (Aperture Stop) | | | D2 | 7.7 | | | |
| r3 | d3 | −12.95 | 4.14 | 8.2 | Ge(4.0032) | −299.96 | f2 |
| r4 | D4 | −16.29 | D4 | 10.2 | | | |
| r5 | d5 | 25.72 | 3.43 | 11 | Ge(4.0032) | 19.61 | f3 |
| r6 | BF | 41.09 | (BF) | 10.2 | | | |

| | |
|---|---|
| Focal Length | f = 25 |
| Entire Length | 47.69 mm |

| | | ½Angle | | | | |
|---|---|---|---|---|---|---|
| Overall Distance | F/No | of View ω | D2 | D4 | BF | m3 |
| At Point Infinity | 1.42 | 12.35 | 15.93 | 8.25 | 9.55 | −0.7 |
| At 1-Meter Ahead | 1.38 | 12.79 | 15.93 | 7.55 | 10.25 | |

(Value Given to the Formula):

| | | |
|---|---|---|
| Formula (1) | 0.5 ≦ f/f1 ≦ 0.7 | f/f1 = 0.60 |
| Formula (2) | 0.01 ≦ \| m3/f1 \| ≦ 0.045 | \| m3/f1 \| = 0.017 |

### Embodiment 5

The following data set is for yet another embodiment in which the second foremost lens piece is to be moved for focusing.

| | |
|---|---|
| # | Surface Number |
| R | Radius of Curvature |
| d | Lens Thickness or Distance between the Adjacent Surfaces |
| r | Lens Radius |
| n | Refractive Index of Lens Substance |
| f | Focal Length |

| # | | R | d | r | n | f | |
|---|---|---|---|---|---|---|---|
| r1 | d1 | 83.89 | 2.88 | 19 | Ge(4.0032) | 82.87 | f1 |
| r2 | d2 | 123.29 | 9.92 | 18.6 | | | |
| (Aperture Stop) | | | D2 | 15.5 | | | |
| r3 | d3 | −25.9 | 8.29 | 12.8 | Ge(4.0032) | −609.7 | f2 |
| r4 | D4 | −32.58 | D4 | 15.8 | | | |
| r5 | d5 | 51.44 | 6.86 | 14.6 | Ge(4.0032) | 39.22 | f3 |
| r6 | BF | 82.18 | (BF) | 13.3 | | | |

| | |
|---|---|
| Focal Length | f = 50 |
| Entire Length | 94.67 mm |

| | | ½Angle | | | | |
|---|---|---|---|---|---|---|
| Overall Distance | F/No | of View ω | D2 | D4 | BF | m2 |
| At Point Infinity | 1.41 | 6.28 | 31.87 | 16.51 | 18.34 | 15.91 |
| At 1-Meter Ahead | 1.53 | 5.83 | 47.78 | 0.6 | 18.34 | |

(Value Given to the Formula):

| | | |
|---|---|---|
| Formula (1) | 0.5 ≦ f/f1 ≦ 0.7 | f/f1 = 0.60 |
| Formula (2) | 0.06 ≦ \| m2/f1 \| ≦ 0.22 | \| m2/f1 \| = 0.19 |

### Embodiment 6

The following data set is for further another embodiment in which the third lens piece is to be moved for focusing.

| | |
|---|---|
| # | Surface Number |
| R | Radius of Curvature |
| d | Lens Thickness or Distance between the Adjacent Surfaces |
| r | Lens Radius |
| n | Refractive Index of Lens Substance |
| f | Focal Length |

| # | | R | d | r | n | f | |
|---|---|---|---|---|---|---|---|
| r1 | d1 | 82.87 | 2.88 | 10 | Ge(4.0032) | 82.42 | f1 |
| r2 | d2 | 121.02 | 9.92 | 9.7 | | | |
| (Aperture Stop) | | | D2 | 7.7 | | | |
| r3 | d3 | −25.9 | 8.29 | 8.2 | Ge(4.0032) | −609.7 | f2 |
| r4 | D4 | −32.58 | D4 | 10.2 | | | |
| r5 | d5 | 51.44 | 6.86 | 11 | Ge(4.0032) | 39.22 | f3 |
| r6 | BF | 82.18 | (BF) | 10.2 | | | |

| | |
|---|---|
| Focal Length | f = 50 |
| Entire Length | 96.44 mm |

| | | ½Angle | | | | |
|---|---|---|---|---|---|---|
| Overall Distance | F/No | of View ω | D2 | D4 | BF | m3 |
| At Point Infinity | 1.4 | 6.28 | 31.87 | 16.51 | 18.33 | −2.7 |
| At 1-Meter Ahead | 1.33 | 6.65 | 31.87 | 13.81 | 21.03 | |

(Value Given to the Formula):

| | | |
|---|---|---|
| Formula (1) | 0.5 ≦ f/f1 ≦ 0.7 | f/f1 = 0.61 |
| Formula (2) | 0.01 ≦ \| m3/f1 \| ≦ 0.045 | \| m2/f1 \| = 0.033 |

### Embodiment 7

The following data set is for another embodiment in which the third foremost lens piece is to be moved for focusing.

| | |
|---|---|
| # | Surface Number |
| R | Radius of Curvature |
| d | Lens Thickness or Distance between the Adjacent Surfaces |
| r | Lens Radius |
| n | Refractive Index of Lens Substance |
| f | Focal Length |

| # | | R | d | r | n | f | |
|---|---|---|---|---|---|---|---|
| r1 | d1 | 45.02 | 1.5 | 10.9 | Ge(4.0032) | 44.05 | f1 |
| r2 | d2 | 66.54 | 6.39 | 10.6 | | | |
| (Aperture Stop) | | | D2 | 7.7 | | | |
| r3 | d3 | −10.9 | 3.13 | 8.2 | Ge(4.0032) | −368.25 | f2 |
| r4 | D4 | −13.38 | D4 | 10.1 | | | |
| r5 | d5 | 25.72 | 3.43 | 10.8 | Ge(4.0032) | 19.61 | f3 |
| r6 | BF | 41.09 | (BF) | 10.1 | | | |

| | |
|---|---|
| Focal Length | f = 25 |
| Entire Length | 47.69 mm |

| | | ½Angle | | | | |
|---|---|---|---|---|---|---|
| Overall Distance | F/No | of View ω | D2 | D4 | BF | m3 |
| At Point Infinity | 1.35 | 12.4 | 15.93 | 7.52 | 9.79 | −0.7 |
| At 1-Meter Ahead | 1.32 | 12.8 | 15.93 | 6.82 | 10.49 | |

(Value Given to the Formula):

| | | |
|---|---|---|
| Formula (1) | 0.5 ≦ f/f1 ≦ 0.7 | f/f1 = 0.57 |
| Formula (2) | 0.01 ≦ \| m3/f1 \| ≦ 0.045 | \| m3/f1 \| = 0.016 |

### Embodiment 8

The following data set is for still another embodiment in which the third foremost lens piece is to be moved for focusing.

| | |
|---|---|
| # | Surface Number |
| R | Radius of Curvature |
| d | Lens Thickness or Distance between the Adjacent Surfaces |
| r | Lens Radius |
| n | Refractive Index of Lens Substance |
| f | Focal Length |

| # | | R | d | r | n | f | |
|---|---|---|---|---|---|---|---|
| r1 | d1 | 81.11 | 2.86 | 18.8 | Ge(4.0032) | 73.08 | f1 |
| r2 | d2 | 125.25 | 7.47 | 18.3 | | | |
| (Aperture Stop) | | | D2 | 15.6 | | | |
| r3 | d3 | −25.57 | 9.33 | 12.3 | Ge(4.0032) | −1210.9 | f2 |
| r4 | D4 | −32.8 | D4 | 15.4 | | | |
| r5 | d5 | 51.44 | 6.86 | 13.4 | Ge(4.0032) | 32.99 | f3 |
| r6 | BF | 82.18 | (BF) | 12.1 | | | |

| | |
|---|---|
| Focal Length | f = 50 |
| Entire Length | 90.48 mm |

| | | ½Angle | | | | |
|---|---|---|---|---|---|---|
| Overall Distance | F/No | of View ω | D2 | D4 | BF | m3 |
| At Point Infinity | 1.43 | 6.26 | 31.87 | 16.53 | 15.56 | −2.87 |
| At 1-Meter Ahead | 1.33 | 6.7 | 31.87 | 13.66 | 18.43 | |

(Value Given to the Formula):

| | | |
|---|---|---|
| Formula (1) | 0.5 ≦ f/f1 ≦ 0.7 | f/f1 = 0.68 |
| Formula (2) | 0.01 ≦ \| m3/f1 \| ≦ 0.045 | \| m3/f1 \| = 0.039 |

What is claimed is:

1. A lens suitable for infrared cameras, comprising the foremost or first single spherical lens piece of positive refractivity, the succeeding or second single spherical lens piece of negative refractivity, and the third single spherical lens piece of positive refractivity, at least the second single spherical lens piece of negative refractivity or the third single spherical lens piece of positive refractivity being to be moved for focusing.

2. The lens suitable for infrared cameras according to claim 1, wherein the second single spherical lens piece of negative refractivity alone is to be moved for focusing.

3. The lens suitable for infrared cameras according to claim 1, wherein the third single spherical lens piece of positive refractivity alone is to be moved for focusing.

4. The lens suitable for infrared cameras according to claim 1, wherein the lens meets the requirement as defined in the following formula:
0.5≦f/f1≦0.7 (1)
where f is a focal length of the entire lens system, and f1 is the focal length of the foremost or first single spherical lens piece of positive refractivity.

5. The lens suitable for infrared cameras according to claim 1, wherein the second single lens piece of negative refractivity is to be moved for focusing, and the lens meets the requirement as defined in the following formula:
0.06≦|m2/f1|≦0.22 (2)
where m2 is a displacement of the second single spherical lens of negative refractivity in the event of the object distance ranging from infinity to 1 m, and f1 is a focal distance of the foremost or first single spherical lens piece of positive refractivity.

6. The lens suitable for infrared cameras according to claim 1, wherein the third single spherical lens piece of negative refractivity is to be moved for focusing, and the lens satisfies the requirement as defined in the following formula:
0.01≦|m3/f1|≦0.045 (3)
where m3 is a displacement of the third single spherical lens of positive refractivity in the event of the object distance ranging from infinity to 1 m, and f1 is a focal distance of the foremost or first single spherical lens piece of positive refractivity.

7. The lens suitable for infrared cameras according to claim 1, wherein all the first to fourth lens pieces are made of germanium.
